(19) United States
(12) Patent Application Publication
(10) Pub. No.: US 2022/0309214 A1
(43) Pub. Date: Sep. 29, 2022

(54) CFD NUMERICAL SIMULATION BASED FLUID EQUIPMENT RESISTANCE OPTIMIZATION ALGORITHM

(71) Applicant: Zhengzhou University of Aeronautics, Zhengzhou (CN)

(72) Inventors: Litao Zhang, Zhengzhou (CN); Yingchao Zhao, Zhengzhou (CN); Yongwei Zhou, Zhengzhou (CN); Yifan Zhang, Zhengzhou (CN); Xin Liao, Zhengzhou (CN); Erbao Feng, Zhengzhou (CN)

(21) Appl. No.: 17/214,866

(22) Filed: Mar. 28, 2021

(51) Int. Cl. G06F 30/28; G06T 17/20

(52) U.S. Cl. CPC G06F 30/28; G06T 17/20; G06T 2210/24; G06F 2111/10

(57) ABSTRACT

The present invention relates to a CFD numerical simulation based fluid equipment resistance optimization algorithm, including the following steps: establishing a fluid equipment unit library; establishing CFD models of fluid equipment units in the fluid equipment unit library, and obtaining a correspondence between a flow rate and a resistance of each fluid equipment unit based on a CFD model of the fluid equipment unit; obtaining fluid equipment units that constitute to-be-tested fluid equipment, and a quantity and a connection sequence of the fluid equipment units; calculating a resistance of each fluid equipment unit based on a flow rate and a correspondence between the flow rate and the resistance of each fluid equipment unit; and adding up resistances of the fluid equipment units in the to-be-tested fluid equipment based on their connection sequence, to obtain a resistance of the to-be-tested fluid equipment.

### TECHNICAL FIELD

The present invention belongs to the field of fluid equipment resistance calculation base, and specifically, relates to a CFD numerical simulation based fluid equipment resistance optimization algorithm.

### BACKGROUND

At present, a fluid system mostly includes a pipeline, a valve, and main equipment. Power of working fluid flow in the fluid system usually comes from a pump or a compressor and matches a flow resistance generated by another component. Therefore, in the design stage of fluid equipment, for reliability of power equipment selection, it is necessary to estimate a resistance of the fluid equipment.

CFD, short for computational fluid dynamics (Computational Fluid Dynamics), is an emerging cross-discipline that integrates fluid mechanics and computer science. Based on a calculation method, CFD uses a fast computing capability of a computer to obtain an approximate solution of a fluid control equation. CFD sprang up in the 1960s. With the rapid development of computers after the 1990s, CFD developed rapidly, and gradually became an important means in product development together with experimental fluid mechanics.

The method of using CFD software to calculate a resistance of fluid equipment is establishing a CFD model of the fluid equipment, and then calculating the resistance of the fluid equipment with reference to a flow rate and the CFD model of the fluid equipment. Therefore, in this method of calculating a fluid resistance, a new CFD model of the fluid equipment needs to be established upon each structure change of the fluid equipment, which is time-consuming and reduces work efficiency.

### SUMMARY

The objective of the present invention is to provide a CFD numerical simulation based fluid equipment resistance optimization algorithm to resolve a problem of low working efficiency in calculating a resistance of fluid equipment in the prior art.

To achieve the foregoing objective, the following technical solutions are used in the present invention.

A CFD numerical simulation based fluid equipment resistance optimization algorithm is provided, and includes the following steps:

(1) establishing a fluid equipment unit library;

where the fluid equipment unit library stores a plurality of fluid equipment units for constituting fluid equipment;

(2) establishing CFD models of the fluid equipment units in the fluid equipment unit library, and obtaining a correspondence between a flow rate and a resistance of each fluid equipment unit based on a CFD model of the fluid equipment unit;

(3) obtaining fluid equipment units that constitute to-be-tested fluid equipment, and a quantity and a connection sequence of the fluid equipment units;

(4) calculating a resistance of each fluid equipment unit based on a flow rate and the correspondence between the flow rate and the resistance of each fluid equipment unit; and

(5) adding up resistances of the fluid equipment units based on the connection sequence of the fluid equipment units in the to-be-tested fluid equipment, to obtain a resistance of the to-be-tested fluid equipment.

Further, the method of establishing CFD models of the fluid equipment units includes the following steps:

establishing geometric models of the fluid equipment units;

meshing a geometric model of each fluid equipment unit; and

importing a meshed geometric model of the fluid equipment unit into CFD software to obtain a CFD model of the fluid equipment unit.

Further, the method of obtaining a correspondence between a flow rate and a resistance of the fluid equipment unit based on the CFD model of the fluid equipment unit is: selecting a specified quantity of flow rate values and resistance values corresponding to the flow rate values from the CFD model of the fluid equipment unit; and fitting the flow rate values and the resistance values to obtain a relationship between the flow rate and the resistance of the fluid equipment unit.

Further, a fitting formula used for fitting the flow rate values and the resistance values of the fluid unit is:

F/L=a₀+a₁(Q/s)+a₂(Q/s)²

where F is the resistance value, L is a distance between an inlet and an outlet of the fluid equipment unit, Q is a volume flow rate, s is an equivalent flow area of the fluid equipment unit, a₀ is a constant, and a₁ and a₂ are fitting coefficients.

Further, the fluid equipment units include more than one of a straight pipe, a U-shaped pipe, a T-shaped pipe, an L-shaped pipe, an adapter pipe, and a valve.

Beneficial effects of the present invention: In the technical solutions provided in the present invention, the fluid equipment unit library is first established, and the correspondence between the flow rate and the resistance of the fluid equipment unit is obtained based on the CFD model of the fluid equipment unit, and finally, the resistances of the fluid equipment units constituting the to-be-tested fluid equipment are obtained, to obtain the resistance of the to-be-tested fluid equipment. According to the technical solutions provided in the present invention, when a structure of the to-be-tested fluid equipment changes, only the quantity and the connection mode of the fluid units need to be obtained to calculate the resistance, with no need to rebuild a CFD model of the fluid equipment, thereby resolving a problem of low working efficiency in calculating a resistance of fluid equipment in the prior art.

The present invention relates to a CFD numerical simulation based fluid equipment resistance optimization algorithm, including the following steps: establishing a fluid equipment unit library; establishing CFD models of fluid equipment units in the fluid equipment unit library, and obtaining a correspondence between a flow rate and a resistance of each fluid equipment unit based on a CFD model of the fluid equipment unit; obtaining fluid equipment units that constitute to-be-tested fluid equipment, and a quantity and a connection sequence of the fluid equipment units; calculating a resistance of each fluid equipment unit based on a flow rate and a correspondence between the flow rate and the resistance of each fluid equipment unit; and adding up resistances of the fluid equipment units in the to-be-tested fluid equipment based on their connection sequence, to obtain a resistance of the to-be-tested fluid equipment. According to the technical solutions provided in the present invention, only a quantity and a connection mode of fluid units in to-be-tested fluid equipment need to be obtained to calculate a resistance of the to-be-tested fluid equipment, thereby resolving a problem of low working efficiency in calculating a resistance of fluid equipment in the prior art.

### BRIEF DESCRIPTION OF DRAWINGS

FIG. 1 is a flowchart of a CFD numerical simulation based fluid equipment resistance optimization algorithm according to an embodiment of the present invention.

### DESCRIPTION OF EMBODIMENTS

The embodiments provide a CFD numerical simulation based fluid equipment resistance optimization algorithm, which is a method for obtaining a resistance of fluid equipment based on CFD numerical simulation, and is used to calculate a resistance received by fluid equipment and resolve a problem of low working efficiency in calculating a resistance of fluid equipment in the prior art.

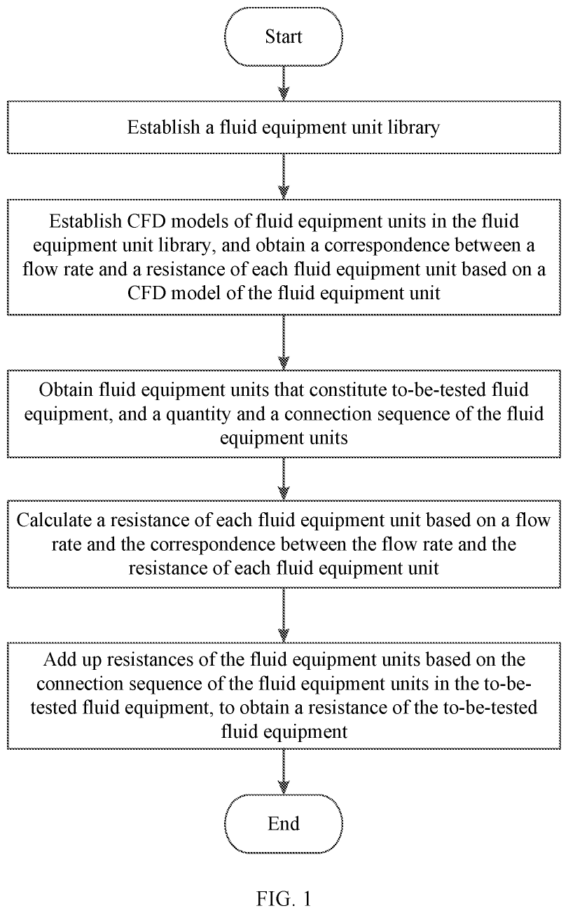

As shown in FIG. 1, the CFD numerical simulation based fluid equipment resistance optimization algorithm provided in this embodiment, whose procedure includes the following steps:

(1) Establish a fluid equipment unit library.

The established fluid equipment unit library stores a plurality of fluid equipment units for constituting fluid equipment. In this embodiment, the fluid equipment units include a straight pipe, a U-shaped pipe, a T-shaped pipe, an L-shaped pipe, an adapter pipe, and a valve. The to-be-tested fluid equipment is constituted by the fluid equipment units in the fluid equipment unit library through connection.

(2) Establish CFD models of the fluid equipment units in the fluid equipment unit library, and obtain a correspondence between a flow rate and a resistance of each fluid equipment unit based on a CFD model of the fluid equipment unit.

The method of establishing CFD models of the fluid equipment units in this embodiment includes the following steps:

establishing geometric models of the fluid equipment units;

meshing an established geometric model of each fluid equipment unit; and

importing a meshed geometric model of the fluid equipment unit into CFD software to obtain a CFD model of the fluid equipment unit.

In this embodiment, Auto CAD software is used to establish the geometric model of the fluid equipment unit, and Star-CD software is used as the CFD software to establish the CFD model.

The method of obtaining a correspondence between a flow rate and a resistance of each fluid equipment unit based on a CFD model of the fluid equipment unit includes the following steps:

first, establishing a fitting relationship between the flow rate and the resistance of the fluid equipment unit, where

the fitting relationship between the flow rate and the resistance of the fluid equipment unit established in this embodiment is:

F/L=a₀+a₁(Q/s)+a₂(Q/s)²

where F is the resistance value, L is a distance between an inlet and an outlet of the fluid equipment unit, Q is a volume flow rate, s is an equivalent flow area of the fluid equipment unit, a₀ is a constant, and a₁ and a₂ are fitting coefficients;

then, selecting three flow rate values from the CFD model of the fluid equipment unit, and obtaining resistance values corresponding to these three flow rate values; and

finally, substituting the three flow rate values and their corresponding resistance values into the foregoing fitting relationship to obtain an equation set containing three equations; and solving the equations to obtain coefficients in the above fitting relationship, so that the relationship between the flow rate and the resistance of the fluid equipment unit can be obtained.

According to the foregoing method, the relationship between the flow rate and the resistance of each fluid equipment unit is sequentially obtained.

(3) Obtain fluid equipment units that constitute to-be-tested fluid equipment, and a quantity and a connection sequence of the fluid equipment units.

The to-be-tested fluid equipment includes the fluid equipment units. Based on an overall structure of the to-be-tested fluid equipment, the quantity and the connection sequence of the fluid equipment units can be obtained.

(4) Calculate a resistance of each fluid equipment unit based on a flow rate and the correspondence between the flow rate and the resistance of each fluid equipment unit.

The resistance of each fluid equipment unit can be calculated by substituting the flow rate into the relationship between the flow rate and the resistance of each fluid equipment unit.

(5) Add up resistances of the fluid equipment units based on the connection sequence of the fluid equipment units in the to-be-tested fluid equipment, to obtain a resistance of the to-be-tested fluid equipment.

In this embodiment, the to-be-tested fluid equipment is regarded as a system formed by the plurality of fluid equipment units connected in series. Therefore, the resistance of the to-be-tested fluid equipment can be calculated by adding up the resistances of the fluid equipment units based on the connection sequence of the fluid equipment units in the to-be-tested fluid equipment.

In other embodiments, types of the fluid equipment units may be some but not all of straight pipes, U-shaped pipes, T-shaped pipes, L-shaped pipes, adapter pipes, and valves.

The embodiments of the present invention disclosed above are only used to help clarify the technical solutions of the present invention, and do not elaborate all the details, nor limit the present invention to only the specific embodiments described. Obviously, many modifications and changes can be made according to the content of this specification. In this specification, selection and specific descriptions of these embodiments are to better explain the principles and practical applications of the present invention, so that those skilled in the art can understand and use the present invention well. The present invention is only limited by the claims and their full scope and equivalents.

Persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A CFD numerical simulation based fluid equipment resistance optimization algorithm, comprising the following steps:
(1) establishing a fluid equipment unit library;
wherein the fluid equipment unit library stores a plurality of fluid equipment units for constituting fluid equipment;
(2) establishing CFD models of the fluid equipment units in the fluid equipment unit library, and obtaining a correspondence between a flow rate and a resistance of each fluid equipment unit based on a CFD model of the fluid equipment unit;
(3) obtaining fluid equipment units that constitute to-be-tested fluid equipment, and a quantity and a connection sequence of the fluid equipment units;
(4) calculating a resistance of each fluid equipment unit based on a flow rate and the correspondence between the flow rate and the resistance of each fluid equipment unit; and
(5) adding up resistances of the fluid equipment units based on the connection sequence of the fluid equipment units in the to-be-tested fluid equipment, to obtain a resistance of the to-be-tested fluid equipment.

2. The CFD numerical simulation based fluid equipment resistance optimization algorithm according to claim 1, wherein the method of establishing CFD models of the fluid equipment units comprises the following steps:
establishing geometric models of the fluid equipment units;
meshing a geometric model of each fluid equipment unit; and
importing a meshed geometric model of the fluid equipment unit into CFD software to obtain a CFD model of the fluid equipment unit.

3. The CFD numerical simulation based fluid equipment resistance optimization algorithm according to claim 1, wherein the method of obtaining a correspondence between a flow rate and a resistance of a fluid equipment unit based on the CFD model of the fluid equipment unit is: selecting a specified quantity of flow rate values and resistance values corresponding to the flow rate values from the CFD model of the fluid equipment unit; and fitting the flow rate values and the resistance values to obtain a relationship between the flow rate and the resistance of the fluid equipment unit.

4. The CFD numerical simulation based fluid equipment resistance optimization algorithm according to claim 3, wherein a fitting formula used for fitting the flow rate values and the resistance values of the fluid unit is:
F/L=a₀+a₁(Q/s)+a₂(Q/s)²
wherein F is the resistance value, L is a distance between an inlet and an outlet of the fluid equipment unit, Q is a volume flow rate, s is an equivalent flow area of the fluid equipment unit, a₀ is a constant, and a₁ and a₂ are fitting coefficients.

5. The CFD numerical simulation based fluid equipment resistance optimization algorithm according to claim 1, wherein the fluid equipment units comprise more than one of a straight pipe, a U-shaped pipe, a T-shaped pipe, an L-shaped pipe, an adapter pipe, and a valve.
